(19) United States
(12) Patent Application Publication
(10) Pub. No.: US 2011/0094546 A1
(43) Pub. Date: Apr. 28, 2011

(54) SYSTEM AND METHOD FOR WAFER CARRIER VIBRATION REDUCTION

(76) Inventors: John Valcore, Mountain View, CA (US); Valeriy Litvak, Los Gatos, CA (US); Christine Cyterski, Santa Clara, CA (US)

(21) Appl. No.: 12/620,338

(22) Filed: Nov. 17, 2009

Related U.S. Application Data
(60) Provisional application No. 61/254,536, filed on Oct. 23, 2009.

(51) Int. Cl. B08B 3/00

(52) U.S. Cl. 134/137; 134/32

(57) ABSTRACT

An aspect of the present invention provides a system and method for controlling a wafer cleaning system having a wafer carrier and a driving portion. The wafer carrier can move along a path in a first direction and a second direction. The driving portion can controllably move the wafer carrier in the first direction and the second direction. The control system includes a vibration sensor portion and a wafer carrier position controller. The vibration sensor portion can detect vibration of the wafer carrier and can output a vibration signal based on the detected vibration. The wafer carrier position controller can instruct the driving portion to modify motion of the wafer carrier based on the vibration signal to reduce the detected vibration.

The present application claims priority from U.S. Provisional Application No. 61/254,536 filed Oct. 23, 2009, the entire disclosure of which is incorporated herein by reference.

### BACKGROUND

In semiconductor chip fabrication, the process of plasma etching is known to leave undesired residues and particles. If left on the wafer, these residues and particles become defects that will cause electrical faults and device failures. When these particles and residues are removed in chemical cleaning processes, device yield will increase and failures will be reduced. However, care must be taken such that the chemical cleaning process effectively removes residues and particles and also that it does not introduce any damage to the wafer. Therefore, it is imperative that chemical cleaning processes are accurately monitored and sufficiently optimized such that the wafers are cleaned as efficiently as possible yet are not damaged in any way.

Conventional cleaning methods typically involve cleaning batches of wafers in a tank over long chemical exposure times. This method of cleaning may lead to within wafer and wafer-to-wafer cross contamination and damage from inadequate drying or over exposure to chemistry. A conventional solution to this is a method that cleans wafers individually by passing a wafer through a confined chemical meniscus, which eliminates the above issues.

FIG. 1 illustrates a portion of a conventional linear wet chemical cleaning system 100.

As illustrated in FIG. 1, cleaning system 100 includes a holding tray 102, a wafer carrier 104, a drain 106, a powered (Magnetic) rail 112, attachment devices 110, 114, 126 and 130, a non-powered (Dummy) rail 128, a cleaning portion 118 and a wafer carrier position controller 132. Cleaning portion 118 includes a plurality of process shower heads 120.

In operation, a wafer 108 may be disposed on wafer carrier 104. Attachment devices 110 and 114 and attachment devices 126 and 130 attached to wafer carrier 104 enable wafer carrier 104 to glide along a path D between powered rail 112 and non-powered rail 128, respectively. The movement of carrier tray 104 (e.g. its velocity) along path D is controlled by wafer carrier position controller 132. During cleaning, wafer carrier 104 first moves along path D in a direction d₁ (left to right) before moving back to its start position (direction d₂). As wafer carrier 104 carrying wafer 108 passes underneath cleaning portion 118, process shower heads 120 apply cleaning solutions to the surface of wafer 108. Process shower heads 120 then remove the cleaning solution via vacuum, while some liquids are drained via drain 106. In this manner, any particulates on the surface of wafer 108 are removed.

In a wet cleaning process, cleaning solutions are applied to the surface of wafer 108 in conjunction with de-ionized water delivery and mixed liquid-gas return lines (not shown). During this process, liquids are also displaced on the surface of holding tray 102, powered rail 112, and non-powered rail 128. In the presence of liquid on powered rail 112 and non-powered rail 128, it has been found that the vibration of wafer carrier 104 will increase in frequency relative to vibrations associated with powered rail 112 and non-powered rail 128 being void of any soluble solution. Further, as wafer carrier 104 moves across holding tray 102, the contact resistance between non-powered rail 128 and attachment devices 110 and 114 and also between powered rail 112 and attachment device 126 and 130 varies due to the presence of the surface residue. With these large variations in contact resistance, wafer 108 tends to oscillate within wafer carrier 104, either moving within or falling completely off of wafer carrier 104. Displacement of wafer 108 during the cleaning process is undesirable and must be minimized in order to prevent wafer damage and to improve the efficiency of the cleaning process.

What is needed is a system and method to prevent the wafer from moving within the carrier structure during a wet clean process.

### BRIEF SUMMARY

It is an object of the present invention to provide a system and method to prevent the wafer from moving within the carrier structure during a wet clean process.

In accordance with an aspect of the present invention, a system and method are provided for controlling a wafer cleaning system having a wafer carrier and a driving portion. The wafer carrier can move along a path in a first direction and a second direction. The driving portion can controllably move the wafer carrier in the first direction and the second direction. The control system includes a vibration sensor portion and a wafer carrier position controller. The vibration sensor portion can detect vibration of the wafer carrier and can output a vibration signal based on the detected vibration. The wafer carrier position controller can instruct the driving portion to modify motion of the wafer carrier based on the vibration signal to reduce the detected vibration.

Additional objects, advantages and novel features of the invention are set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIG. 1 illustrates a portion of a conventional linear wet chemical cleaning system;

FIGS. 2A-2E illustrate graphs depicting the response of piezoelectric sensors for the movement of wafer carrier in one direction across holding tray during a dry trial cleaning process;

FIGS. 3A-3E illustrate graphs depicting the response of piezoelectric sensors for the movement of water carrier in the opposite direction across holding tray, during a dry trial cleaning process;

FIG. 4A illustrates a filtered response from a sensor while undergoing two consecutive dry trial cleaning processes;

FIG. 4B illustrates another filtered response from both another sensor while undergoing two consecutive dry trial cleaning processes;

FIG. 5A illustrates filtered responses from a sensor during dry trial cleaning processes;

FIG. 5B illustrates filtered responses from a sensor during wet cleaning trial processes; and

FIG. 6 illustrates an example wafer cleaning and control system in accordance with an aspect of the present invention.

### DETAILED DESCRIPTION

In accordance with an aspect of the present invention, a system and method provides the ability to detect movement of a carrier structure by monitoring vibrations associated with motion of the carrier structure on a wet chemical cleaning system and the ability to reduce unwanted movement of the carrier structure by adjusting the movement control based on the monitored vibrations.

Specifically, in accordance with an aspect of the present invention, the system includes a vibration sensor portion in addition to a wafer carrier position controller. The vibration sensor portion can detect vibration of the wafer carrier structure and can output a vibration signal based on the detected vibration. The wafer carrier position controller can then instruct the driving portion to modify motion of the wafer carrier structure based on the vibration signal in order to reduce the detected vibration. In this manner, the movement of a wafer within the carrier structure can be significantly reduced during the cleaning process.

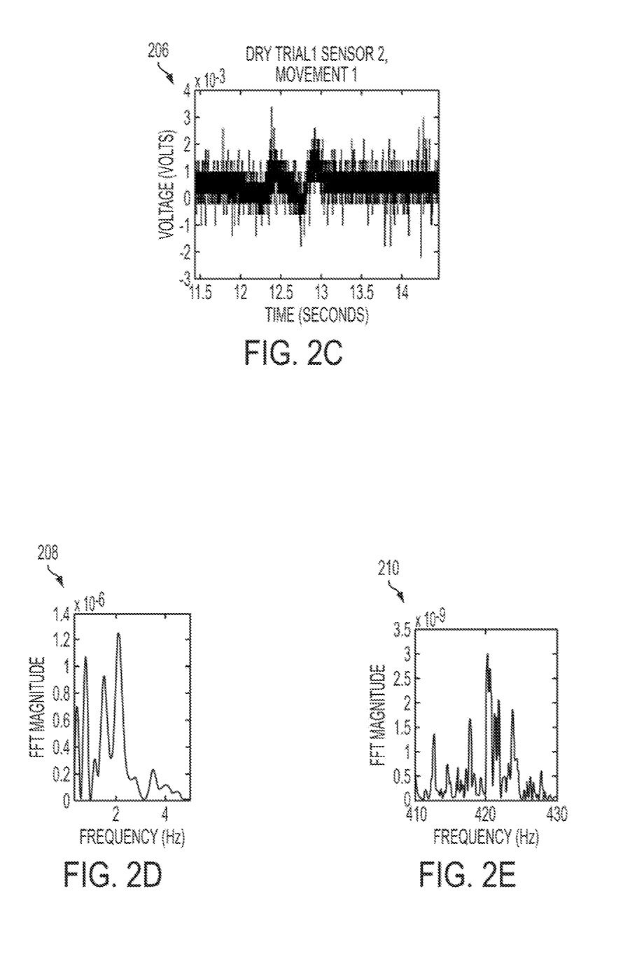

Aspects of the present invention will now be described in greater detail with reference to FIGS. 2A-6.

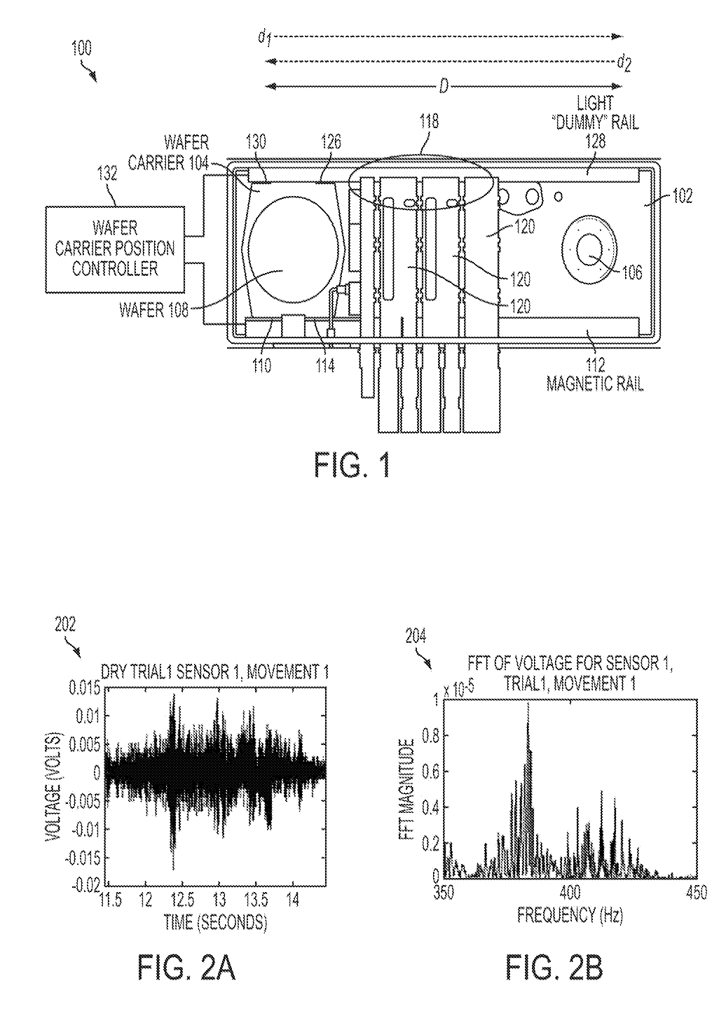

In an embodiment consistent with an aspect of the present invention, a vibration sensor portion consists of a first sensor (Sensor 1) and a second sensor (Sensor 2), which are each placed on non-powered rail 128 and powered rail 112, respectively, in cleaning system 100 of FIG. 1 in order to measure the vibrations associated with the movement of carrier tray 104 along holding tray 102. Types of sensors that may be used include piezoelectric film, MEMS, or optical sensors but may be any type of sensor that can detect vibration. The responses from each sensor are first measured during a “dry” cleaning process, in which wafer carrier 104 moves back and forth across holding tray 102 (along directions d₁ and d₂) but no liquids or residues are present on either powered rail 112 or on non-powered rail 128. This provides for a “baseline” response for the sensors, which represents the ideal, or minimal amount of vibration associated with the movement of wafer carrier 104 during the cleaning process.

Then, the sensor response is again measured during a “wet” cleaning process, in which wafer carrier 104 moves back and forth across holding tray 102 (in directions d₁ and d₂), this time with fluid present on powered rail 112 and on non-powered rail 128. The changes in the sensor responses can thus quantify the amount of vibration of wafer carrier 104 introduced by the presence of fluid. In this manner one gains the ability to detect and characterize the vibrations of wafer carrier 104 associated with the presence of fluid during a regular wet cleaning process, and therefore allows for in-situ monitoring and adjustment of the position of wafer carrier 104 in order to reduce movement of wafer 108 during the cleaning process.

FIGS. 2A-2E illustrate a set of graphs depicting the response of piezoelectric sensors for the movement of wafer carrier 104 in one direction across holding tray 102 (moving in direction d₁, or from start position to end position, labeled as “Movement 1”) during a “dry” trial cleaning process (no fluids present). Sensor 1 refers to the sensor placed at non-powered rail 128, and Sensor 2 refers to the sensor placed at powered rail 112.

Specifically, FIG. 2A includes a graph 202, which illustrates the voltage output of Sensor 1 as a function of time, as wafer carrier 104 moves across holding tray 102 in direction d₁ (Movement 1). FIG. 2B includes a graph 204, which is a Fast-Fourier Transform (FFT) of the voltage output in graph 202, illustrating FFT magnitude as a function of frequency. FIG. 2C is a graph 206, which illustrates the voltage output of Sensor 2 as a function of time, as wafer carrier 104 moves across holding tray 102 in direction d₁ (Movement 1). FIG. 2D and FIG. 2E includes graphs 208 and 210, respectively, which show FFT magnitude as a function of frequency of the voltage signal in graph 206.

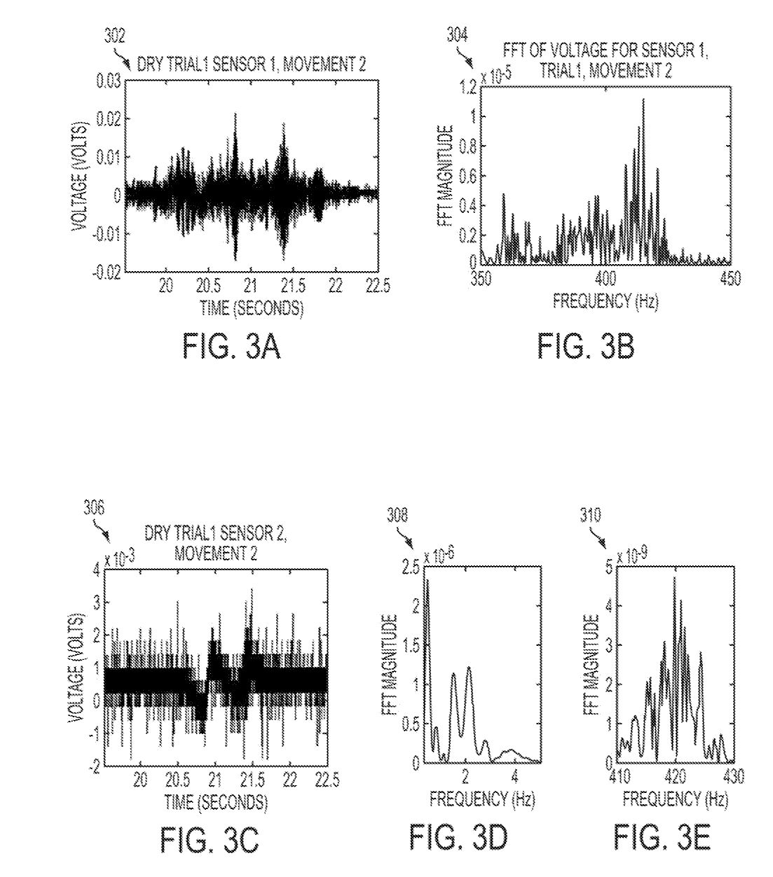

FIGS. 3A-3E illustrate a set of graphs depicting the response of piezoelectric sensors during the movement of wafer carrier 104 in the opposite direction across holding tray 102 (in direction d₂, or from end position back to start position, labeled as “Movement 2”) during a “dry” trial cleaning process (no fluids present). FIG. 3A is a graph 302, which illustrates the voltage output of Sensor 1 as a function of time, as wafer carrier 104 moves across holding tray 102 along direction d₂ (Movement 2). FIG. 3B is a graph 304, which is an FFT of the voltage output in graph 302, illustrating FFT magnitude as a function of frequency. FIG. 3C is a graph 306, which illustrates the voltage output of Sensor 2 as a function of time, as wafer carrier 104 moves across holding tray 102 along direction d₂ (Movement 2). FIG. 3D and FIG. 3E includes graphs 308 and 310, respectively, which show FFT magnitude as a function of frequency of the voltage signal in graph 306.

As wafer carrier 104 moves across holding tray 102 in direction d1 (Movement 1), the frequency response of the vibration signal from Sensor 1 (FIG. 2B) and Sensor 2 (FIGS. 2D and 2E) are measured under the ideal condition, i.e., powered rail 112 and non-powered rail 128 both void of any liquids or foreign particulates. Then as wafer carrier 104 moves back to start in direction d₂ (Movement 2), the frequency response of the vibration signal from Sensor 1 (FIG. 3B) and Sensor 2 (FIGS. 3D and 3E) are similarly measured. These data provide a set of “baseline” frequency responses for the vibrations of wafer carrier 104 as it moves across holding tray 102, in the absence of any liquids or particulates.

Given that the mass of powered rail 112 and non-powered rail 128 are not equal, the response from the sensor on the rail with less mass (Sensor 1, on non-powered rail 128) has stronger high frequency components. This can be seen by comparing the magnitude of frequencies in FIG. 28 to those in FIG. 2E. Sensor 1 is dominated by higher frequencies than Sensor 2, however, it was found that both Sensor 1 and Sensor 2 contained low frequency components between 1 and 10 Hz.

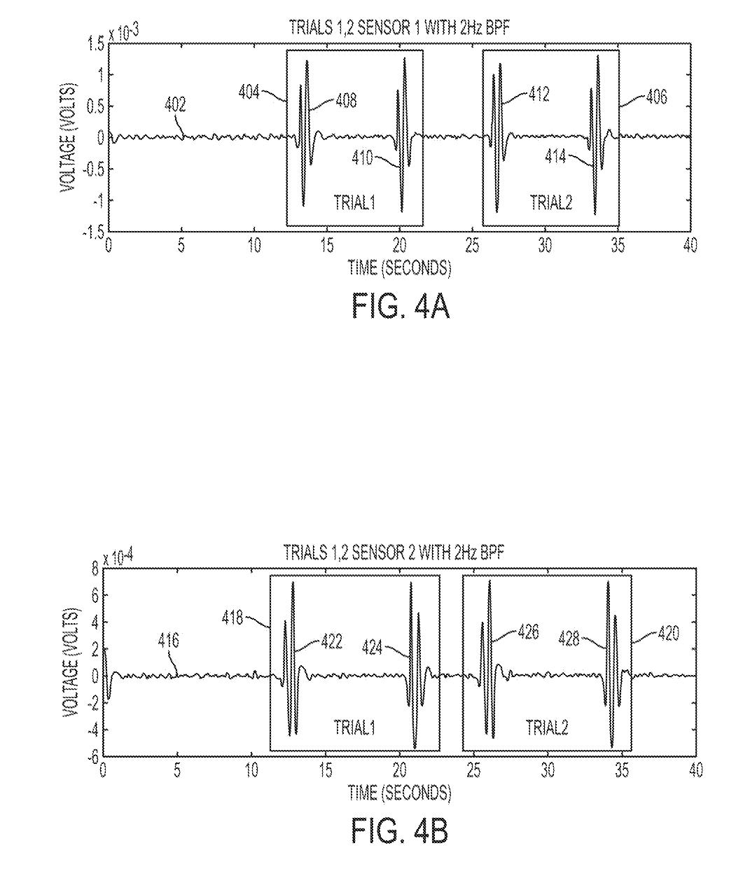

FIGS. 4A and 4B illustrate the filtered response from both Sensor 1 and Sensor 2, while undergoing two consecutive “dry” trial cleaning processes (no fluids present). FIG. 4A shows the filtered response from Sensor 1 (sensor attached to non-powered rail 128) during these two dry trials. The y-axis is the filtered response from Sensor 1 (in volts), whereas the x-axis is time (in seconds). Portion 402 refers to period of time where the first trial (Trial 1) has just begun and carrier 104 is moving in direction d₁ (Movement 1), by gliding along powered rail 112 and non-powered rail 128. Here, the response from Sensor 1 during portion 402 is very small, since wafer carrier 104 has not yet passed over the location of Sensor 1 (under process shower heads 120) and therefore negligible vibrations are detected.

Block 404 refers to the portion of Trial 1 in which wafer carrier 104 is moving near Sensor 1. A large response (portion 408) is observed by Sensor 1 as wafer carrier 104 first passes over Sensor 1 as part of Movement 1 (wafer carrier 104 moving in direction d₁). Then, after wafer carrier 104 reaches the end position of holding tray 102 and begins to move in direction d₂ back to the start position (Movement 2), it passes over Sensor 1 again and thus another large response (portion 410) is similarly observed.

Following Trial 1, a second identical dry trial (Trial 2) immediately begins. Block 406 refers to the portion of Trial 2 in which wafer carrier 104 is moving near Sensor 1. As seen in Trial 1, there is a large response from Sensor 1 as wafer carrier 104 passes over Sensor 1 during Movement 1 (portion 412) and Movement 2 (portion 414). Note that the shape and magnitude of the signals in portions 408 and 410 of Trial 1 and portions 412 and 414 of Trial 2 are very similar to each other. These consistent, repeatable results thus suggest that this filtered signal provides a stable “baseline” response of Sensor 1 for further evaluating vibrations due to the movement of wafer carrier 104.

FIG. 4B shows the filtered response from Sensor 2 (sensor attached to powered rail 112) during the same two dry trials. The y-axis is the filtered response from Sensor 2 (in volts), whereas the x-axis is time (in seconds). Portion 416 refers to period of time where the first trial (Trial 1) has just begun and carrier 104 is moving in direction d₁ (Movement 1), by gliding along powered rail 112 and non-powered rail 128. Here, the response from Sensor 2 during portion 416 is very small, since wafer carrier 104 has not yet passed over the location of Sensor 2 (under process shower heads 120) and therefore only negligible vibrations are detected.

Block 418 refers to the portion of Trial 2 in which wafer carrier 104 is moving near Sensor 2. A large response (portion 422) is observed by Sensor 2 as wafer carrier 104 first passes over Sensor 2 as part of Movement 1 (wafer carrier 104 moving in direction d₁). Then, after wafer carrier 104 reaches the end position of holding tray 102 and begins to move in direction d₂ back to the start position (Movement 2), it passes over Sensor 2 again and thus another large response (portion 424) is similarly observed.

Following Trial 1, a second identical dry trial (Trial 2) immediately begins. Block 420 refers to the portion of Trial 2 in which wafer carrier 104 is moving near Sensor 2. As seen in Trial 1, there is a large response from Sensor 2 as wafer carrier 104 passes over Sensor 2 during Movement 1 (portion 426) and Movement 2 (portion 428). Note that the shape and magnitude of the signals in portions 422 and 424 of Trial 1 and portions 426 and 428 of Trial 2 are very similar to each other. These consistent, repeatable results thus suggest that this filtered signal provides a stable “baseline” response of Sensor 2 for further evaluating vibrations due to the movement of wafer carrier 104.

Since FIG. 4A and FIG. 4B showed that both the filtered signals of Sensor 1 and Sensor 2 provide for consistent responses upon repeated dry trials, these filtered signals can therefore be used as a baseline for the monitoring and optimization of vibrations during the cleaning process. Specifically, since the baseline responses represent the ideal, or minimal, amount of vibration associated with the movement of wafer carrier 104, they can thus be used for comparison when monitoring the responses during regular (or “wet”) cleaning processes.

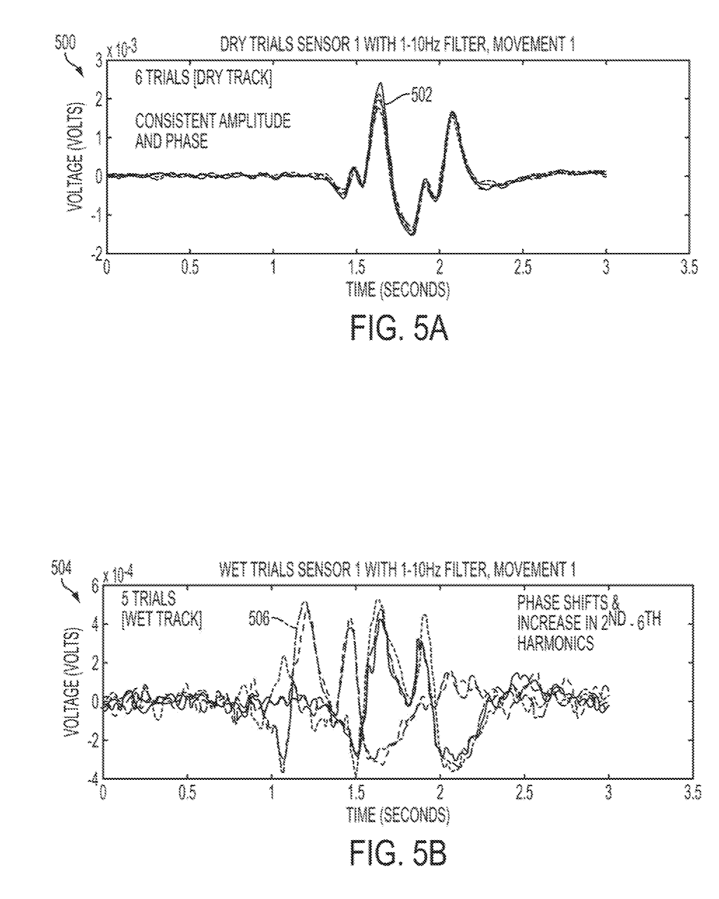

By using the repeatable low frequency components evident from both Sensor 1 and Sensor 2, one may also be able to detect the changes in the contact resistance between non-powered rail 128 and attachment devices 126 and 130, and between powered rail 112 and attachment devices 110 and 114. In the example discussed with reference to FIGS. 2-4, it was found that a 1-10 Hz bandpass filter on the responses of Sensor 1 and 2 was sufficient for detecting changes in frequency response as a result of changes due to contact resistance. The change in frequency response as a function of contact resistance will be discussed below with reference to FIGS. 5A-5B. For the sake of brevity, in FIGS. 5A and 5B, only the responses from one sensor (Sensor 1) are shown.

FIGS. 5A and 5B illustrate the filtered response from Sensor 1 during dry trial cleaning processes (FIG. 5A) and wet cleaning trial processes (FIG. 5B).

Specifically, FIG. 5A is a graph 500, which illustrates the filtered response from Sensor 1 during six identical “dry” trial cleaning processes (no fluids present on powered rail 112 or non-powered rail 128). The y-axis is the filtered response from Sensor 1 (in volts), whereas the x-axis is time (in seconds). Set 502 is the set of the six filtered signals from Sensor 1 obtained from the six dry trials. As shown in the figure, all six curves in set 502 are very consistent with each other, each having consistent amplitude and phase. This behavior is expected, since during dry trials only minimal vibration is present due to the relatively constant contact resistance. This minimal vibration is presumably acceptable as it does not cause Significant movement of wafer 108 within wafer carrier 104.

FIG. 5B is a graph 504, which illustrates the filtered response from Sensor 1 during five identical “wet” cleaning processes (fluids sprayed directly onto powered rail 112 and non-powered rail 128). Set 506 is the set of the five filtered signals from Sensor 1 obtained from the five wet trials. As shown in the figure, the curves in set 506 vary greatly from one to the other, exhibiting large phase shifts, variations in amplitude and higher-order harmonics. This variation can be attributed to the increase in the frequency of the vibrations detected by Sensor 1 which directly result from the variations in contact resistance caused by the presence of fluid. This increase in vibration frequency is undesirable because it can cause excessive movement of wafer 108 within wafer carrier 104, even to the point of wafer 108 falling completely off of wafer carrier 104. Thus, this additional vibration due to the presence of fluid is unacceptable and must be addressed in order to reduce unwanted movement of wafer 108 during the cleaning process.

FIGS. 5A and 5B illustrate how by tracking the changes in frequency, amplitude, and phase of the responses from Sensor 1, one has the ability to gauge the variations in vibrations and contact resistance due to the presence of fluid on non-powered rail 128. A similar case can be said for Sensor 2 and the responses due to fluid present on powered rail 112. In accordance with an aspect of the present invention, this monitoring of vibrations is performed in real time, during the cleaning process such that this information can be then be utilized to monitor and appropriately control the movement of wafer carrier 104 (or other dynamic process variables) in order to reduce the movement of wafer 108 within wafer carrier 104.

Specifically, in situ frequency analysis of the vibrations from Sensor 1 and Sensor 2 are performed such that explicit frequency domain attributes for each signal response can be obtained and used to identify the nature of unwanted vibrations caused by fluid and/or residue build up on powered rail 112 and/or non-powered rail 128. The data from this in situ analysis can be then used in real-time to control the movement of wafer carrier 104 in such a way as to destructively interfere with the unwanted vibrations. This thus allows for real-time control of the movement of wafer carrier 104 (and other dynamic process variables) such that the overall movement of wafer 108 within wafer carrier 104 is reduced during the cleaning process. This can prevent catastrophic failures by ensuring that wafer 108 remains stable on wafer carrier 104 at all times.

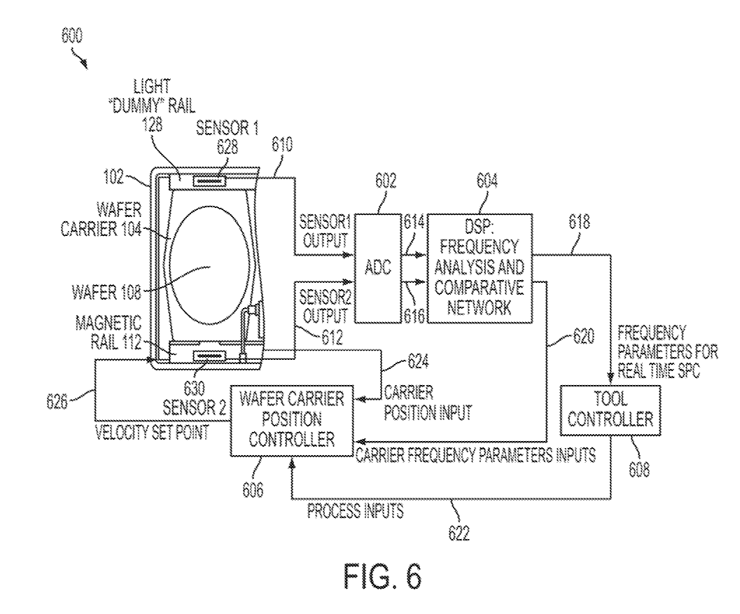

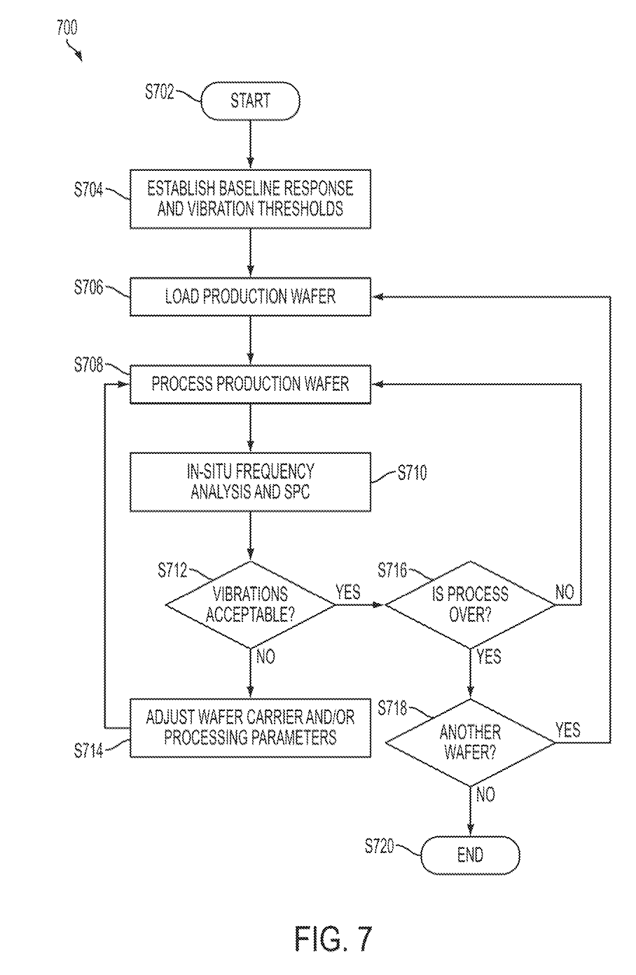

An example embodiment in accordance with an aspect of the present invention which implements this monitoring and control will now be described with reference to FIG. 6.

FIG. 6 illustrates a wafer cleaning and control system 600 in accordance with an aspect of the present invention. FIG. 6 includes a cleaning system 100, a first sensor 628 (Sensor 1), a second sensor 630 (Sensor 2), an analog-to-digital converter (ADC) 602, a digital signal processor (DSP) 604, a wafer carrier position controller 606 and a tool controller 608.

ADC 602 is arranged to receive a Sensor 1 output 610 and a Sensor 2 output 612 as inputs and output a Sensor 1 digital signal 614 and a Sensor 2 digital signal 616. DSP 604 is arranged to receive Sensor 1 digital signal 614 and Sensor 2 digital signal 616 as inputs and output statistical process control (SPC) frequency parameters 618 and a carrier frequency parameter input 620. Tool controller 608 is arranged to receive SPC frequency parameters 618 and output a process input 622. Wafer carrier position controller 606 is arranged to receive a carrier position input 624, carrier frequency parameter input 620, process input 622 and output a carrier velocity set point 626.

In operation, during the cleaning process, as wafer carrier 104 moves across holding tray 102, the analog voltage signals from first sensor 628 and second sensor 630 (Sensor 1 output 610 and Sensor 2 output 612) are input into ADC 602. ADC 602 then converts Sensor 1 output 610 and Sensor 2 output 612 into digital signals, Sensor 1 digital signal 614 and Sensor 2 digital signal 616. Then DSP 604 receives Sensor 1 digital signal 614 and Sensor 2 digital signal 616 and processes the signals, which may include filtering (e.g., digital bandpass) and an FFT to identify the frequency composition of the vibrations (magnitude and phase responses). DSP 604 also includes a database of various baseline data obtained during dry trials for which to perform analyses on the frequency composition. The output signal SPC frequency parameters 618 output from DSP 604 thus may include magnitude and phase information that are supplied to tool controller 608 to perform real time SPC and compare the parameters of the current trial to that of the other trials in the lot. In order to ensure run-to-run repeatability between wafers in a lot, tool controller 608 outputs process input 622 to wafer carrier position controller 606, which includes feedback parameters to appropriately adjust the speed and/or position of wafer carrier 104 such that its movement remains as uniform as possible throughout all the trials in the lot. This is done by wafer carrier position controller 606 receiving process input 622 and carrier position input 624 and outputting the appropriate velocity set point 626, which sets the velocity of wafer carrier 104.

Note that DSP 604 also provides another output, carrier frequency parameter input 620, that is fed directly to wafer carrier position controller 606, bypassing tool controller 608. This is done so that DSP 604 can directly control wafer carrier position controller 606, in the event that DSP 604 determines that there is an unacceptable amount of excess vibration. In this case, carrier frequency parameter input 620 contains parameters for a signal that is designed to slow down movement of wafer carrier 104 to reduce these excess vibrations. Wafer carrier position controller 606 receives carrier frequency parameter input 620 and outputs the appropriate velocity set point 626, which sets the velocity of wafer carrier 104 such that the excess vibrations are reduced as much as possible. In the case of extremely high excess vibration, wafer carrier position controller 606 may simply set the velocity set point 626 to zero (thereby temporarily halting wafer carrier 104) in order to prevent wafer 108 from falling off of wafer carrier 104.

In this manner, in cleaning and control system 600, the stability of wafer 108 within wafer carrier 104 is improved and catastrophic failures due to wafer 108 falling off wafer carrier 104 are prevented, thereby improving the overall efficiency of the cleaning process. Further, process uniformity throughout a lot is improved as SPC is also utilized in the control of wafer carrier 104.

An example method of operating cleaning and control system 600 in accordance with an aspect of the present invention will now be described with additional reference to FIG. 7.

Process 700 starts (step S702) and a baseline for the vibration of wafer carrier 104 during the cleaning process is established (step S704). As discussed previously, this is done by measuring the responses from Sensor 1 and Sensor 2 during “dry” cleaning trial processes, in which no liquids or residues are present on non-powered rail 128 or non-powered rail 112. The responses from each sensor are then processed to obtain a baseline response which represents the ideal, or minimal, amount of vibration during a cleaning process. Thresholds for vibrations exceeding the baseline by specific amounts may also established, such that beyond certain thresholds, a given vibration response is deemed to be unacceptable and therefore requires adjustment.

Then, a production wafer is loaded (step S706) and the production wafer is processed in cleaning and control system 600 (step S708). While the wafer is processed, the responses from Sensor 1 and Sensor 2 are monitored and in-situ frequency analysis and SPC are performed (step S710). As previously described in reference to FIG. 6, DSP 604 processes the digital responses from both sensors, performing frequency analysis and comparing the frequency parameters to the established baseline responses. Tool controller 608 performs SPC by comparing the frequency parameter data from the current trial to those of other trials in the lot and instructing wafer carrier position controller 606 to adjust the velocity of wafer carrier 104 accordingly. Other processing parameters (such as amount of cleaning fluid dispensed, position of process shower heads 120) may also be adjusted.

If/when the measured vibration responses exceed the established vibration thresholds (step S712), the velocity of water carrier 104 and/or other processing parameters are appropriately adjusted to reduce the vibration to an acceptable level (step S714). Referring back to FIG. 6, by comparing the measured vibration to established baseline responses, DSP 604 determines if the amount of excess vibration falls within the established threshold. If not, DSP 604 outputs carrier frequency parameter input 620 to wafer carrier position controller 606, and the velocity of wafer carrier 104 is adjusted during the cleaning process such that the excess vibrations are canceled out or reduced via destructive interference.

After the appropriate parameters are adjusted, the process of cleaning and in-situ monitoring of the vibrations is repeated (step S708) until it is again determined if the vibrations currently being measured are acceptable (step S712). If the vibrations currently being measured are acceptable, it is then determined whether the cleaning process for the current wafer is over (step S716).

If it is determined that the cleaning process is not over, then the process of cleaning and in-situ monitoring continues (step S708).

If it is determined that the cleaning process is over, then it is determined whether more production waters need to be processed (step S718). If more production wafers do not need to be processed, then processing may conclude (step S720), otherwise the next production wafer is loaded (step S706) and the process repeats.

In accordance with aspects of the present invention, vibrations associated with wafer carrier movement on a wet chemical cleaning system may be detected and used to prevent the wafer from moving within the carrier structure. Vibration sensors may be used to detect carrier vibrations relative to its movement along the system track, while dynamic in-situ frequency analysis can provide appropriate feedback parameters as inputs to the wafer carrier velocity control loop in order to attenuate unwanted frequencies associated with wafer displacement.

The foregoing description of various preferred embodiments of the invention have been presented for purposes of illustration and description. It is not intended to be exhaustive or to limit the invention to the precise forms disclosed, and obviously many modifications and variations are possible in light of the above teaching. The exemplary embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. A control system for use with a wafer cleaning system having a wafer carrier and a driving portion, the wafer carrier operable to move along a path in a first direction and a second direction, the driving portion operable to controllably move the wafer carrier in the first direction and the second direction, said control system comprising:
a vibration sensor portion operable to detect vibration of the wafer carrier and to output a vibration signal based on the detected vibration; and
a wafer carrier position controller operable to instruct the driving portion to modify motion of the wafer carrier based on the vibration signal to reduce the detected vibration.

2. The control system of claim 1, further comprising a processing portion operable to provide a first analysis of vibration of the wafer carrier at a first time period, based on the vibration signal at the first time period, to provide a second analysis of vibration of the wafer carrier at a second time period, based on the vibration signal at the second time period, and to generate a compared signal based on a comparison of the first analysis and the second analysis.

3. The control system of claim 2, wherein said processing portion is further operable to establish a threshold and to generate a threshold signal when a difference between the first analysis and the second analysis is greater than the threshold.

4. The control system of claim 3, wherein said wafer carrier position controller is further operable to instruct the driving portion to modify motion of the wafer carrier based on the threshold signal.

5. The control system of claim 1, wherein said sensor portion comprises a first vibration sensor and a second vibration sensor,
wherein said first vibration sensor is disposed at a first location and is operable to detect a first vibration of the wafer carrier and to output a first vibration signal based on the detected first vibration, and
wherein said second vibration sensor disposed at a second location and is operable to detect a second vibration of the wafer carrier and to output a second vibration signal based on the detected second vibration.

6. The control system of claim 5, further comprising a processing portion operable to provide a first analysis of vibration of the wafer carrier at a first time period, based on at least one of the first vibration signal at the first time period and the second vibration signal at the first time period, to provide a second analysis of vibration of the wafer carrier at a second time period, based on at least one of the first vibration signal at the second time period and the second vibration signal at the second time period, and to generate a compared signal based on a comparison of the first analysis and the second analysis.

7. The control system of claim 6, wherein said processing portion is further operable to establish a threshold and to generate a threshold signal when a difference between the first analysis and the second analysis is greater than the threshold.

8. The control system of claim 7, wherein said wafer carrier position controller is further operable instruct the driving portion to modify motion of the water carrier based on the threshold signal.

9. A method of controlling a wafer cleaning system having a wafer carrier and a driving portion, the wafer carrier operable to move along a path in a first direction and a second direction, the driving portion operable to controllably move the wafer carrier in the first direction and the second direction, said method comprising:
detecting vibration of the wafer carrier;
outputting a vibration signal based on the detected vibration; and
instructing the driving portion to modify motion of the wafer carrier based on the vibration signal to reduce the detected vibration.

10. The method of claim 9, further comprising:
providing a first analysis of vibration of the wafer carrier at a first time period, based on the vibration signal at the first time period;
providing a second analysis of vibration of the wafer carrier at a second time period, based on the vibration signal at the second time period; and
generating a compared signal based on a comparison of the first analysis and the second analysis.

11. The method of claim 10, further comprising:
establishing a threshold; and
generating a threshold signal when a difference between the first analysis and the second analysis is greater than the threshold.

12. The method of claim 11, further comprising instructing the driving portion to modify motion of the wafer carrier based on the threshold signal.

13. The method of claim 9,
wherein said detecting vibration of the wafer carrier comprises detecting a first vibration of the wafer carrier and detecting a second vibration of the wafer carrier, and
wherein said outputting a vibration signal based on the detected vibration comprises outputting a first vibration signal based on the detected first vibration and outputting a second vibration signal based on the detected second vibration.

14. The method of claim 13, further comprising:
providing a first analysis of vibration of the wafer carrier at a first time period, based on at least one of the first vibration signal at the first time period and the second vibration signal at the first time period;
providing a second analysis of vibration of the wafer carrier at a second time period, based on at least one of the first vibration signal at the second time period and the second vibration signal at the second time period; and
generating a compared signal based on a comparison of the first analysis and the second analysis.

15. The method of claim 14, further comprising:
establishing a threshold; and
generating a threshold signal when a difference between the first analysis and the second analysis is greater than the threshold.

16. The method of claim 15, further comprising instructing the driving portion to modify motion of the wafer carrier based on the threshold signal.
